(19) United States
(12) Patent Application Publication
(10) Pub. No.: US 2006/0285658 A1
(43) Pub. Date: Dec. 21, 2006

(54) Message management methods and apparatus for audio storage systems

(76) Inventors: Chin-Shu Lin, Cupertino, CA (US); Jiann Cherng Luh, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/142,991

(22) Filed: Jun. 1, 2005

(51) Int. Cl. H04M 1/64

(52) U.S. Cl. 379/67.1

(57) ABSTRACT

Message management methods and apparatus for managing messages in a multi-message audio recording and playback system with a memory device having first and second storage ends comprising storing successive messages sequentially in the memory device, allowing the controllable erasing of only the oldest message or the newest message still stored in the memory device, the erasing of messages freeing respective parts of the memory device for the recording of further messages, and when reaching the first end of the memory device while recording a message, continuing to record the message starting at the first end of the memory device. Allowing erasing of only the oldest or the newest message still recorded keeps the stored messages in contiguous storage locations, eliminating fragmented messages and the requirement of storing information regarding memory management in non-volatile memory on power down, as any information needed for operation of the audio recording and playback device may be recovered on power up be simply scanning the memory using a relatively simple algorithm.

### BACKGROUND OF THE INVENTION

1. Field of the Invention

The present invention relates to the field of message management methods and apparatus for audio storage systems, and particularly for managing multiple message recording, playback and erasing.

2. Prior Art

Integrated circuit audio storage systems are well known in the prior art. Such integrated circuits include the ChipCorder Voice and Data Record and Playback systems manufactured by Winbond Electronics Corporation of Hsinchu, Taiwan. These integrated circuits sample an analog signal, typically an analog audio signal, and store the samples in a multi-level floating gate storage array, one sample per storage cell. The memory is organized as a two dimensional array having a width or row width, and a length or number of rows dependent on the record time implemented. Addresses are in effect addresses for each entire row. The readout voltage range of stored analog voltages is predetermined, and does not include the output voltage characteristic of a fully programmed or fully erased memory cell. Among other things, this allows storage of digital information in the same storage array, such as end of message (EOM) signals uniquely distinguishable from an output voltage indicative of the storage of a message sample. Erasing of messages is done by simply writing zeros in the memory locations being erased, thereby creating empty memory cells.

Other integrated circuit audio storage systems are also well known in the prior art, such as by way of example, integrated circuits that digitize an audio input signal and store the digital signals in multiple storage cells as binary numbers. Whatever the storage technique, audio storage systems need to provide a message management feature for a user to manipulate the stored messages, such as to play, erase, record, forward and perform other message management functions.

Existing audio storage systems use micro-controller/processors with control software to manage the messages. The software controls the operations, for example, of record, play, erase and forward operations. During recording, it directs and stores the incoming message/data to empty memory cells. On playback, message/data will be retrieved from memory cells in the same order it was recorded. Thus the control software needs to store the address information for all messages so it can be retrieved correctly. The erase feature allows a user to erase a recorded message. After a message is erased, the control software will free the memory for re-use. Though the address information can be stored in the RAM of a micro-controller, when power is removed (for example changing a battery) the address information will be lost, as RAM needs electric power to retain data. To prevent data being lost, the address information is typically stored in an external (separate) flash memory IC. The drawback of this method is the extra memory IC cost and the effort of software development.

### BRIEF DESCRIPTION OF THE DRAWINGS

FIG. 1 illustrates the arrangement of a memory in a cylindrical structure in accordance with the methods of the present invention.

FIGS. 2.1 through 2.8 illustrate the effect of allowing only the first and last messages to be erasable.

FIGS. 3.1 through 3.8 illustrate the effect of allowing only the first and last messages to be erasable, together with the corresponding positions of various pointers.

FIG. 4 is a logic flow diagram for the preferred embodiment of the present invention.

### DETAILED DESCRIPTION OF THE PREFERRED EMBODIMENTS

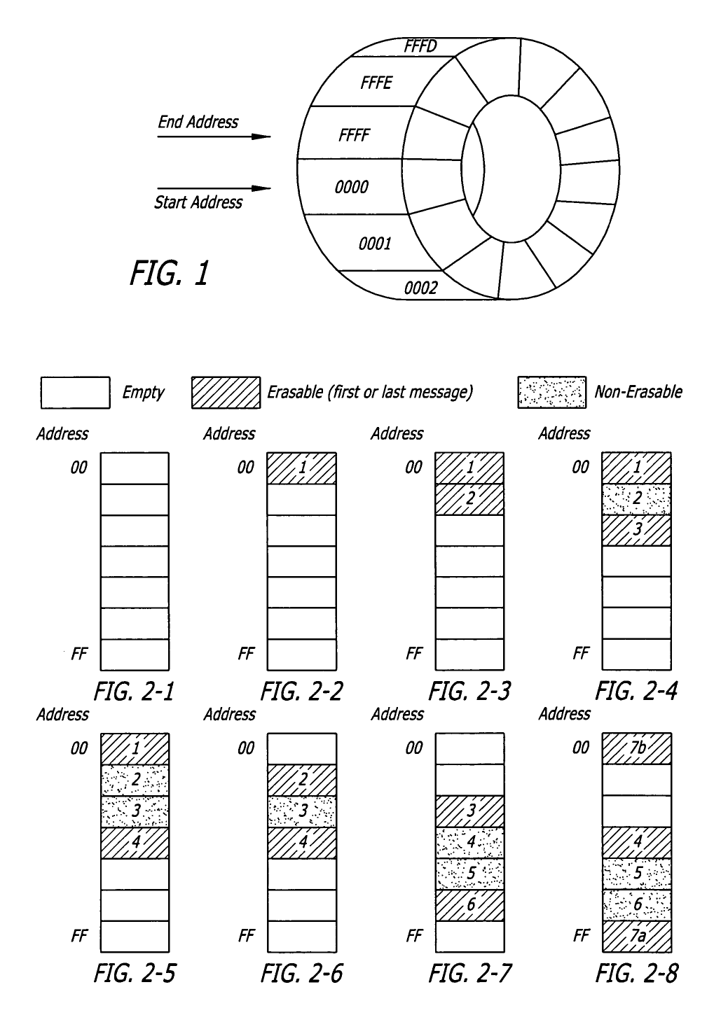

The preferred embodiments of the present invention are simplified message management methods that can be integrated into hardware or implemented through firmware (software). The methods arrange the memory in a cylindrical structure (FIG. 1) and only allow the first (oldest recorded) and last (most recently recorded) messages to be erased. By doing this, all memory cells available for recording new messages are sequential locations so new data can be stored sequentially without fragmentation. This eliminates the need to track addresses of each memory cell for recording, playback and erasing fragmented messages. It also allows locating the beginning of the contiguous memory available for recording, as well as the first or last recorded message for erasing through the use of simple algorithms, eliminating the need for an additional flash memory chip to store the address information, thereby reducing the product cost. Of course, in FIG. 1, as in various other illustrations herein, the memory storage is indicated as ranging from 00 to FF, though of course the memory size is normally chosen to provide a maximum message storage capability in accordance with the application of the storage and playback system.

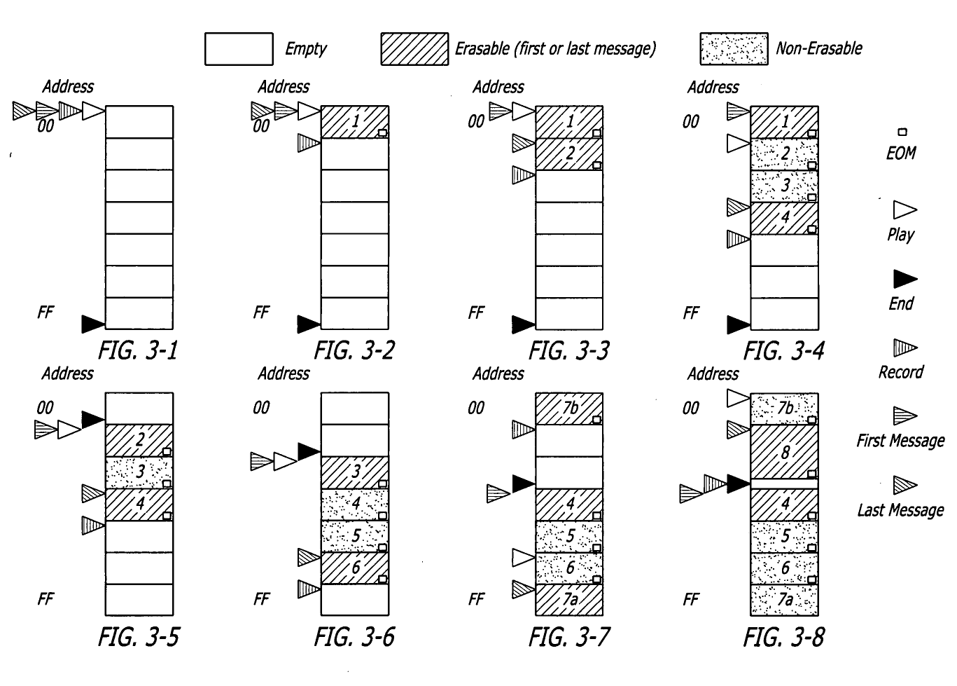

FIG. 2 illustrates the arrangement of empty memory cells in contiguous memory locations by applying the cylindrical structure of FIG. 1 and allowing only the first and last messages to be erasable. As an illustration, consider the example in FIGS. 2.1 through 2.8. In this example as well as the examples of FIGS. 3.1 through 3.8, messages may appear to be of equal length, though this is for illustration convenience and clarity and not a limitation of the invention. Also, each stored message is shown as occupying only one storage location (row in a ChipCorder integrated circuit), when in fact each message normally will require many rows for its storage. Further, only seven storage locations are shown in FIGS. 2.1 to 2.8 and 3.1 to 3.8, labeled 00 and FF at the two ends, though again this is for purposes of illustration only.

Initially, the memory starts with empty cells, as shown in FIG. 2.1. After message 1 is stored starting in location 00 as in FIG. 2.2, message 1 is the first and last message stored, so it is erasable. The message can span many memory cells, but all in sequential addresses. FIG. 2.3 shows that after a second message is stored, both message 1 (first) and message 2 (last) are erasable. After storing the third message as in FIG. 2.4, only the message 1 (first) and message 3 (last) are erasable. After storing a fourth message as in FIG. 2.5, only the message 1 (first or oldest) and message 4 (last or newest) are erasable. If message 1 is erased from FIG. 2.5, messages 2 and 4 become erasable, as shown in FIG. 2.6. Since the memory is arranged in a cylindrical fashion, the empty memory cells are still in sequential locations (as are the used storage cells), as shown in FIG. 2.6. After messages 5 and 6 are recorded as shown in FIG. 2.7, all the empty memory cells are still in sequential locations. When recording message 7, data (7a) will be stored down to the bottom or end of the memory (FF), and thereafter will continue (7b) from the beginning address (00) as shown in FIG. 2.8. Thus by using the cylindrical or wrap around structure and limiting erasability to only the first or earliest message recorded and the last or most recent message recorded, the empty memory cells will shift around, but will always remain in sequential memory locations.

More detail on the operation of this invention is illustrated in FIGS. 3.1 through 3.8. In a preferred embodiment, five pointers are maintained to track the operation, plus an end of message (EOM) signal that is inserted and stored at the end of each message. In the ChipCorder devices, recording of a message will frequently end part way through a row of storage cells, in which case the end of message (EOM) signal will immediately follow somewhere on that row. The EOM signal is to help the system tell where each message ends. The EOM signal can be a few bits of binary data, for example 1010 or 0101, and empty cells can be assigned with all 0s. The setting is not critical as long as they can be identified by the system and not confused with message data itself, i.e. may be uniquely recognized. It is preferably the same for all messages. The five pointers are identified as Play, End, Record, First Message and Last Message. The First Message pointer is to indicate the beginning address of the first message and the Last Message pointer is to indicate the beginning address of the last message. While the end of message signal EOM is stored at the end of each message at the time the message storage is completed, the five pointers need not be stored in nonvolatile memory, hence a flash memory for this purpose is not needed. As shall be subsequently described, the pointers may be easily re-determined on power up by executing a relatively simple algorithm.

The following rules are applied to the preferred embodiment of the present invention:

1. After power up, the system will scan memory from its beginning (00) to its end (FF in the example) to update all pointers as follows:
a. The Play pointer will be set to the beginning of the last message or most recent message still recorded. The address can be identified as the second to the last EOM, +1. In that regard, the last EOM is the one followed by an empty cell, as in the exemplary embodiment, cells storing message data will always contain data different from an empty cell. Once the last EOM is identified, the system can go back to the second to the last EOM. If only one EOM is found, the memory has only one message stored.
b. The Record pointer will be set to the first empty cell following the last message, i.e., the address of the last EOM+1, or to 00 if all messages are erased, ready to start recording a new message.
c. The First Message pointer will be set to the beginning of the first message, ready to play back the first message or oldest message still stored. This is the address of the first non-empty cell that has a proceeding empty cell.
d. The End pointer will be pointed to the address before the First Message pointer, namely the address held as the First Message pointer −1.
e. The Last Message pointer will be set to the second to last EOM, +1, which is the beginning of the last or most recent message still stored.

2. If the memory has no messages stored (empty), there will be no EOM and all memory cells will be empty. All pointers will be at the beginning address except the End pointer, which will point to the last address.

3. When an erase command is received, the system will check to determine if the play pointer is at the beginning of the first or last message before executing the erase. If the play pointer is not equal to the address of the beginning of the First or Last Message pointer, the erase command will be ignored.

4. After a message is erased, the system will rescan the memory to update the pointers.

5. After a new message is recorded, the system will update the Play and Last Message pointers.

6. The End pointer is to indicate the end of the empty memory. It is always one address ahead of the First Message pointer, i.e., First Message pointer −1. During recording, the Record pointer is advanced as recording proceeds, with the recording stopping when the address of the Record pointer reaches the End pointer. Therefore in a preferred ChipCorder embodiment, there will be always one empty row in the memory. This is to help the system to identify the first message.

7. If memory is full, the Record and End pointer will be at the same address.

8. Fault coverage: In a preferred embodiment, if data is recorded but there is no EOM, the system will treat this as an error and will erase all messages to recover.

9. The Play pointer can be advanced to the next message by a Forward command, i.e., advanced to the following EOM+1. If the Play pointer is at the beginning of the last message, the next Forward command will advance the pointer to the beginning of the first message. Note that as a result of the cylindrical structure, the last message still recorded may in fact start at a lower memory address than the first or oldest message still recorded.

FIGS. 3.1 through 3.8 illustrate the foregoing. In particular, FIG. 3.1 illustrates the memory and pointers starting with all empty cells. FIG. 3.2 shows the memory and pointers after message 1 is stored. The Recording pointer will be at the address immediately after the EOM of message 1 (first) and the Play pointer will be pointed to message 1 (last). FIGS. 3.3 and 3.4 illustrate the memory and pointers after more messages are recorded. After power up, the Play pointer will be pointed to the last message. After a message is erased, the system will update all the pointers, as shown in FIGS. 3.5 and 3.6. FIG. 3.7 shows the message 7 was separated into 2 parts of memory. If the memory is full, as shown in FIG. 3.8, one memory cell/row is still empty. The address of the Record pointer will be equal to the End pointer.

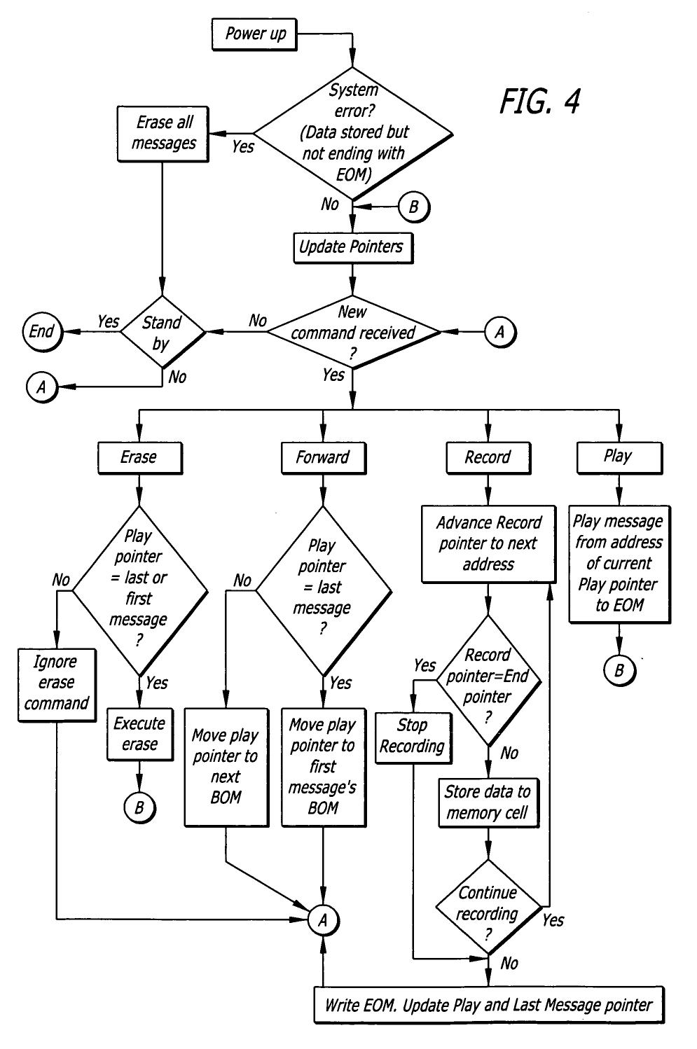

Now referring to FIG. 4, a logic flow diagram for the embodiment of the invention just described may be seen. This diagram is quite self-explanatory, particularly given the prior description, and accordingly will not be exhaustively described in detail herein. However it should be noted that in this embodiment, there are four commands that may be received, namely, erase, forward, record and play. Erase, record and play are self explanatory. The forward command advances the Play pointer to the beginning of the next message. Since on power up, the Play pointer is set to the beginning of the last message still stored, the first forward command will “advance” the Play pointer to the first or oldest message still recorded, and then successively advance on each subsequent forward command. BOM refers to the beginning of a message. In the preferred embodiments there is no beginning of message signal, but rather it is determined for the first message as being the first memory address with stored data following one or more addresses of empty rows, and of course for subsequent messages, is determined as the address of the first row following the end of message signal for the prior message.

In the embodiment described herein the various pointers are determined at the time of power up. Obviously as one alternative, they could be determined as they are needed, though at least for the Record pointer it is preferable to have that pointer set before any message is received so that the recording may start substantially immediately in the beginning of receipt of the message. Also it should be noted that the present invention, while ideally suited to multi-level storage systems such as the ChipCorder Voice and Data Record and Playback System, it could also be used in systems using a different audio signal sample storage technology. Thus the present invention comprises simplified message management methods that can be implemented through software/firmware or integrated into IC logic to provide a simple and low cost solution. Further, in systems which allow the recording over without erasing prior messages, one could record messages indefinitely, with the oldest messages being written over as new messages are recorded. Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A method of managing messages in a multi-message audio recording and playback system with a memory device having first and second storage ends comprising:
storing successive messages sequentially in the memory device;
allowing the controllable erasing of only the oldest message still stored or the newest message still stored in the memory device, the erasing of messages freeing respective parts of the memory device for the recording of further messages; and,
when reaching the first end of the memory device while recording a message, continuing to record the message starting at the first end of the memory device.

2. The method of claim 1 further comprised of stopping the storing of a new message when reaching the beginning of the oldest message still stored in the memory device.

3. The method of claim 2 wherein each message is stored with an end of message signal stored at the end of the message, and wherein when the storing of a new message is stopped because of reaching the beginning of the oldest message still stored in the memory device, an indication thereof is provided where the recording of the new message is stopped.

4. The method of claim 3 wherein the indication of the stopping of a recording because of reaching the beginning of the oldest message still stored in the memory device comprises leaving at least one storage address empty.

5. The method of claim 4 wherein the memory device is a multi-level storage device wherein a single storage cell is used to store a respective audio signal sample.

6. The method of claim 5 wherein audio signal samples are stored in a multi-level voltage range that does not include an output voltage of a fully erased storage cell.

7. The method of claim 6 further comprised of scanning the memory device on power up to set pointers for the operation of the multi-message audio recording and playback system.

8. The method of claim 7 wherein the pointers include a record pointer set to the first empty storage address following the newest message still stored.

9. The method of claim 8 wherein the pointers also include an end pointer set to the address before the beginning of the oldest message still stored.

10. The method of claim 9 wherein the pointers also include a play pointer set to the beginning of the newest message still stored, a first message pointer set to the beginning of the oldest message still stored and a last message pointer set to the beginning of the newest message still stored.

11. A method of managing messages in a multi-message audio recording and playback system with a multi-level floating gate memory array having first and second array ends comprising:
repeatedly sampling an audio signal for each message and storing multiple successive samples in an equal number of storage cells in each of a plurality of successive addresses in the memory array;
storing an end of message indicator at the end of each stored message;
storing successive messages sequentially in the memory array;
allowing the controllable erasing of only the oldest message still stored or the newest message still stored in the memory array, the erasing of messages freeing respective parts of the memory array for the recording of further messages; and,
when reaching the first end of the memory array while recording a message, continuing to record the message starting at the first end of the memory array.

12. The method of claim 11 further comprised of stopping the storing of a new message when reaching the beginning of the oldest message still stored in the memory array.

13. The method of claim 12 wherein each message is stored with an end of message signal stored at the end of the message, and wherein when the storing of a new message is stopped because of reaching the beginning of the oldest message still stored in the memory array, an indication thereof is provided where the recording of the new message is stopped.

14. The method of claim 13 wherein the indication of the stopping of a recording because of reaching the beginning of the oldest message still stored in the memory array comprises leaving at least one storage address empty

15. The method of claim 11 wherein audio signal samples are stored in a multi-level voltage range that does not include an output voltage of a fully erased storage cell.

16. The method of claim 15 further comprised of scanning the memory array on power up to set pointers for the operation of the multi-message audio recording and playback system.

17. The method of claim 16 wherein the pointers include a record pointer set to the first empty storage address following the newest message still stored.

18. The method of claim 17 wherein the pointers also include an end pointer set to the address before the beginning of the oldest message still stored.

19. The method of claim 18 wherein the pointers also include a play pointer set to the beginning of the newest message still stored, a first message pointer set to the beginning of the oldest message still stored and a last message pointer set to the beginning of the newest message still stored.
